(19) United States
(12) Patent Application Publication
(10) Pub. No.: US 2026/0161474 A1
(43) Pub. Date: Jun. 11, 2026

(54) OPTIMIZING LOAD BALANCING IN CONTAINER ORCHESTRATION SYSTEMS

(71) Applicant: SAP SE, Walldorf (DE)

(72) Inventors: Wei Li, Shanghai (CN); Sreekanth Kozhisseri Pattath, Bangalore (IN); Sudheernath Reddy Kaipa, Kadapa(D) (IN); Xiangjun Xiao, Shanghai (CN); Vidhya K, Bangalore (IN); Sreeram V, Palakkad (IN); Shivkumar Chakkenchath, San Ramon, CA (US)

(21) Appl. No.: 18/974,996

(22) Filed: Dec. 10, 2024

(51) Int. Cl. G06F 9/50; G06F 18/232

(52) U.S. Cl. CPC G06F 9/505; G06F 18/232

(57) ABSTRACT

Methods, systems, and computer-readable storage media for executing a load balancer optimization engine for a cluster that includes a set of nodes, a first sub-set of nodes being used for load balancing by one or more external load balancers, a second sub-set of nodes being excluded from load balancing, determining, by the load balancer optimization engine, a delta value based on a pool count and a number of nodes in a candidate node list, transmitting, by the load balancer optimization engine, a request to adjust a number of nodes in the first sub-set of nodes and a number of nodes in the second sub-set of nodes responsive to the delta value, and adjusting, by a cloud controller of the cluster, the number nodes in the first sub-set of nodes by the delta value and a number of nodes in the second sub-set of nodes by the to the delta value.

### BACKGROUND

In modern software deployments, containerization is implemented, which can be described as operating system (OS) virtualization. In containerization, applications (or microservices, software processes) are run in isolated user spaces referred to as containers. The containers use the same shared OS, and each provides a fully packaged and portable computing environment. That is, each container includes everything an application needs to execute (e.g., binaries, libraries, configuration files, dependencies). Because a container is abstracted away from the OS, containerized applications can execute on various types of infrastructure. For example, using containers, an application can execute in any of multiple cloud-computing environments.

Container orchestration automates the deployment, management, scaling, and networking of containers within cloud platforms. For example, container orchestration systems, in hand with underlying containers, enable applications to be executed across different environments (e.g., cloud computing environments) without needing to redesign the application for each environment. Enterprises that need to deploy and manage a significant number of containers (e.g., hundreds or thousands of containers) leverage container orchestration systems. An example container orchestration system is the Kubernetes platform, maintained by the Cloud Native Computing Foundation, which can be described as an open-source container orchestration system for automating computer application deployment, scaling, and management.

In container orchestration systems, such as Kubernetes, clusters include physical hardware (e.g., servers, processors, memory) that execute applications. As physical hardware and operating systems executing thereon are constantly developed and integrated into cloud platforms, it commonly occurs that clusters become heterogenous with respect to capabilities of the physical machines. However, scheduling workloads on heterogenous clusters is challenging and utilization of resources can be limited by the service load balancing strategy implemented by the container orchestration system.

### SUMMARY

Implementations of the present disclosure are directed to balancing workloads across nodes in container orchestration systems. More particularly, and as described in further detail herein, implementations of the present disclosure provide for dynamic optimization of nodes in a pool of nodes handling requests from external load balancers.

In some implementations, actions include executing a load balancer optimization engine for a cluster that includes a set of nodes, a first sub-set of nodes being used for load balancing by one or more external load balancers, a second sub-set of nodes being excluded from load balancing, determining, by the load balancer optimization engine, a delta value based on a pool count and a number of nodes in a candidate node list, transmitting, by the load balancer optimization engine, a request to adjust a number of nodes in the first sub-set of nodes and a number of nodes in the second sub-set of nodes responsive to the delta value, and adjusting, by a cloud controller of the cluster, the number nodes in the first sub-set of nodes by the delta value and a number of nodes in the second sub-set of nodes by the to the delta value. Other implementations of this aspect include corresponding systems, apparatus, and computer programs, configured to perform the actions of the methods, encoded on computer storage devices.

These and other implementations can each optionally include one or more of the following features: the pool count is determined as a configuration parameter stored in a configuration map of the cluster; the pool count is determined based on usage metrics of the cluster; the candidate node list includes one or more nodes in the first sub-set of nodes prior to adjusting the number nodes in the first sub-set of nodes by the delta value; each node in the first sub-set of nodes is absent an exclude label applied thereto and each node in the second sub-set of nodes includes the exclude label applied thereto; adjusting, by a cloud controller of the cluster, the number nodes in the first sub-set of nodes by the delta value and a number of nodes in the second sub-set of nodes by the to the delta value includes one of adding an exclude label to a number of nodes in the first sub-set of nodes equal to the delta value, and removing an exclude label from a number of nodes in the second sub-set of nodes equal to the delta value; and adjusting, by a cloud controller of the cluster, the number nodes in the first sub-set of nodes by the delta value and a number of nodes in the second sub-set of nodes by the to the delta value includes reading node records in a key-value system, each node record representing a respective node of the cluster and a label status of the respective node, and identifying nodes in the node records that have had a change in label status.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example container orchestration architecture.

FIG. 2 depicts an example architecture that can be used to execute implementations of the present disclosure.

FIG. 3A depicts example load balancing absent implementations of the present disclosure.

FIG. 3B depicts example load balancing in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to balancing workloads across nodes in container orchestration systems. More particularly, and as described in further detail herein, implementations of the present disclosure provide for dynamic optimization of nodes in a pool of nodes handling requests from external load balancers.

In some implementations, actions include executing a load balancer optimization engine for a cluster that includes a set of nodes, a first sub-set of nodes being used for load balancing by one or more external load balancers, a second sub-set of nodes being excluded from load balancing, determining, by the load balancer optimization engine, a delta value based on a pool count and a number of nodes in a candidate node list, transmitting, by the load balancer optimization engine, a request to adjust a number of nodes in the first sub-set of nodes and a number of nodes in the second sub-set of nodes responsive to the delta value, and adjusting, by a cloud controller of the cluster, the number nodes in the first sub-set of nodes by the delta value and a number of nodes in the second sub-set of nodes by the to the delta value.

To provide further context for implementations of the present disclosure, and as introduced above, in modern software deployments containerization is implemented, in which applications (or microservices, software processes) are run in isolated user spaces referred to as containers. Container orchestration automates the deployment, management, scaling, and networking of containers. An example container orchestration system is the Kubernetes platform, maintained by the Cloud Native Computing Foundation, which can be described as an open-source container orchestration system for automating computer application deployment, scaling, and management.

With example reference to Kubernetes, Kubernetes manages containers with pods, which are the smallest deployable objects in Kubernetes. The pods are configurable so as to be able to execute any number of services. An application service is a designed process or piece of code that can be executed on a node and executes functionality of an overarching application. Thus, an application service can be implemented on one more pods on a node using the principles of containerization. A group of nodes can be organized into a cluster. In general, if a particular application service needs to be executed, it can be assigned to any of the nodes within that cluster. An application may include one or more application services that, when executed achieve a desired result which are common with various software environments such as human resources, accounting or any enterprise resource planning paradigm. That is, for example, an application can be composed of multiple application services in a service-oriented architecture).

An application service is defined using label selectors to assign nodes to execute each particular application service. Each pod carries a set of labels indicating the one or more application services with which it is associated as application services are assigned and removed from each pod. When a request for a particular application service is received, it is routed to a particular node in the cluster.

In terms of load balancing, Kubernetes provides for internal load balancers and external load balancers. In general, an internal load balancer distributes traffic within a cluster among pods of the same application service. On the other hand, an external load balancer distributes traffic from outside the cluster to appropriate pods within the cluster. The external load balancer exposes instances of the application service to entities (e.g., users, services) outside of the cluster. In some scenarios, a cloud provider implements an external load balancer to distribute requests (network traffic) across multiple instances of an application service executing within a cluster. Here, the external load balancer functions as a traffic manager to ensure that incoming requests are evenly distributed across the instances of the application service to optimize performance and prevent overload on any individual instance of the application service. In this manner, high availability and scalability of the application service is provided.

In some scenarios, cloud providers provide support for external load balancers. In enabling use of external load balancers, a service field type of a service can be set to LoadBalancer, which facilitates the service's exposure to the external environment (external to the cluster) through an external load balancer of the cloud provider. Here, the service is distinct from an application service, discussed above. Instead, a service, such as a service that can be used for external load balancing, can be described as a service that exposes an application (e.g., composed of multiple application services) that is executed across one or more pods within a cluster. The load balancer service (i.e., the service having its service field type set to LoadBalancer) provides an externally-accessible internet protocol (IP) address that sends traffic to a port on cluster nodes. This default implementation sequence in Kubernetes serves as an efficient mechanism for enhancing application accessibility, highlighting the symbiotic relationship between Kubernetes and compatible cloud providers in optimizing load balancing capabilities. In the discussion below, the term service refers to an application service and the terms load balancer service or external load balancer refers to a service having its service field type set to LoadBalancer (i.e., does not execute functionality of an application).

The cloud provider assumes responsibility for provisioning an external load balancer according to specifications of the application service, which specifications are outlined in a service manifest and can include details, such as a type of load balancer (e.g., external), external traffic policy, listener port, and listener protocol, among others. A so-called cloud-controller-manager fine-tunes the load balancer to redirect traffic to the designated node port. To achieve proper load balancing in this scenario, all nodes present within the cluster are listed as available in a backend pool of a nodes for the load balancer listener. The backend pool of nodes are those nodes in the cluster that are either executing a particular service or those that are not currently executing that particular service but could be called upon to execute that service in the future. Therefore, through a systematic and layered approach, Kubernetes facilitates efficient load balancing in the cloud environment.

However, this approach presents certain drawbacks when implemented on a larger scale of Kubernetes clusters. For example, the cloud-controller-manager, by default, adds all nodes in every backend pool of the load balancer. In other words, every node in the cluster is viewed as available regardless of its status as executing a service or not. This can lead to several unintended consequences. From a performance and troubleshooting perspective, ingress traffic may be spread across a greater number of nodes than necessary. Among other issues, this dispersion complicates debugging processes, as it requires checking logs or tracing multiple nodes and/or pods for troubleshooting. Moreover, this configuration is inefficient in terms of technical resources. To highlight this, a non-limiting example can be considered, in which a cluster includes 40 nodes and 3 external load balancer services (e.g., services with a service type of LoadBalancer). In this example, the system requires at least 120 backend pool members (each of the 3 services has its own load balancer where the cloud-controller-manager views each of the load balancers views needing to access each of the 40 nodes, such that 40 nodes multiplied by 3 services yields 120 backend pool members). Therefore, as the cluster size increases, an increasing number of technical resources is wasted.

In view of the above context, implementations of the present disclosure recognize that, to optimize resource usage and performance of cloud computing environments, the default configuration of the cloud-controller-manager needs to be reconsidered in large-scale Kubernetes clusters. As such, implementations of the present disclosure provide a load balancer optimization system that dynamically configures the number of backend nodes available to each load balancer. The backend node number can be adjusted in real-time in correlation to the actual load on the cluster. Further, the load balancer optimization system is integrated with features that optimize ingress traffic flow control, thereby minimizing potential traffic forwarding between nodes (e.g., one-time network address translation (NAT) forwarding between nodes).

As described in further detail herein, Kubernetes automatically enables a ServiceNodeExclusion feature gate, which permits utilization of a label node.kubernetes.io/exclude-from-external-load-balancers on specific nodes. In this manner, nodes can be excluded from the backend pool of nodes (pool members) that receive requests directed by an external load balancer. However, optimization of the present disclosure is responsive to evaluating the implications on the cluster size and load balancer service requirements, among other factors. Further, implementations of the present disclosure enable automation for this process to optimize the efficiency and effectiveness of the system.

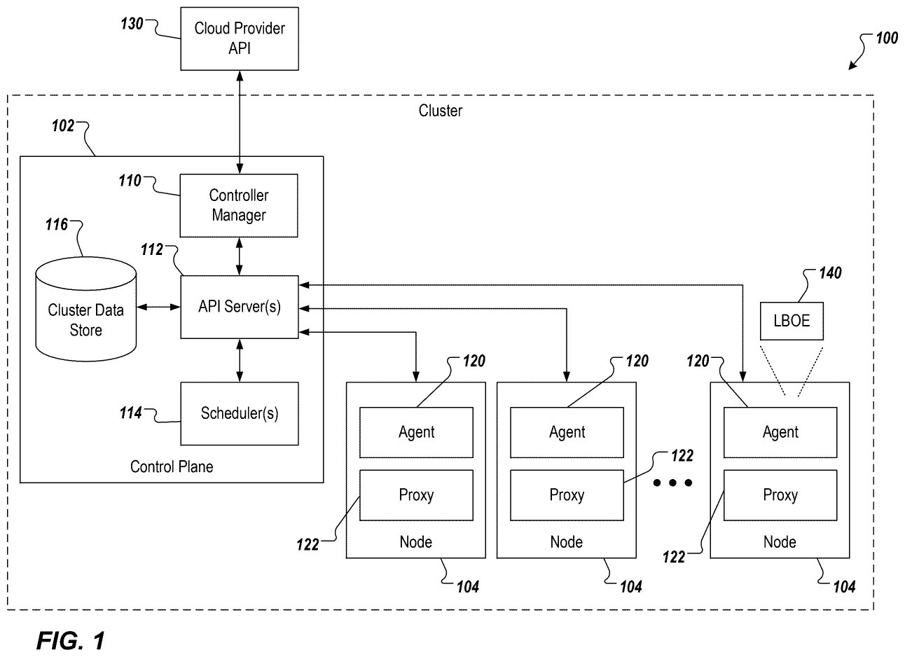

FIG. 1 depicts an example container orchestration architecture 100 in accordance with implementations of the present disclosure. In the depicted example, the example container orchestration architecture 100 represents deployment of a portion of a container orchestration system, Kubernetes introduced above. More particularly, the example architecture 100 represents a basic structure of a cluster within Kubernetes

In the example of FIG. 1, the example architecture 100 includes a control plane 102 and a plurality of nodes 104. Each node 104 can represent physical worker machines and are configured to host pods. In Kubernetes, a pod is the smallest deployable unit of resources and each pod is provided as one or more containers with shared storage/network resources, and a specification for how to run the containers. In some examples, a pod can be referred to as a resource unit that includes an application container. The control plane 102 communicates with the nodes 104 and is configured to manage all of the nodes 104 and the pods therein.

In further detail, the control plane 102 is configured to execute global decisions regarding the cluster as well as detecting and responding to cluster events. In the example of FIG. 1, the control plane 102 includes a controller manager 110, one or more application programming interface (API) server(s) 112, one or more scheduler(s) 114, and a cluster data store 116. The API server(s) 112 communicate with the nodes 104 and exposes the API of Kubernetes to exchange information between the nodes 104 and the components in the control plane 102 (e.g., the cluster data store 116). In some examples, the control plane 102 is set with more than one API server(s) 112 to balance the traffic of information exchanged between the nodes 104 and the control plane 102. The scheduler(s) 114 monitor the nodes 104 and execute scheduling processes to the nodes 104. For example, the scheduler(s) 114 monitors events related to newly created pods and selects one of the nodes 104 for execution, if the newly created pods are not assigned to any of the nodes 104 in the cluster.

The cluster data store 116 is configured to operate as the central database of the cluster. In this example, resources of the cluster and/or definition of the resources (e.g., the required state and the actual state of the resources) can be stored in the cluster data store 116. The controller manager 110 of the control plane 102 communicates with the nodes 104 through the API server(s) 112 and is configured to execute controller processes. The controller processes can include a collection of controllers and each controller is responsible for managing at least some or all of the nodes 104. The management can include, but is not limited to, noticing and responding to nodes when an event occurs, and monitoring the resources of each node (and the containers in each node). In some examples, the controller in the controller manager 110 monitors resources stored in the cluster data store 116 based on definitions of the resource. As introduced above, the controllers also verify whether the actual state of each resource matches the required state. The controller is able to modify or adjust the resources, so that actual state matches the required state depicted in the corresponding definition of the resources.

In the example of FIG. 1, each node 104 includes an agent 120 and a proxy 122. The agent 120 is configured to ensure that the containers are appropriately executing within the pod of each node 104. The agent 120 is referred to as a kubelet in Kubernetes. The proxy 122 of each node 104 is a network proxy that maintains network rules on nodes 104. The network rules enable network communication to the pods in the nodes 104 from network sessions inside or outside of the cluster. The proxy 122 is a kube-proxy in Kubernetes.

In accordance with implementations of the present disclosure, and as described in further detail herein, the load balancer optimization engine is deployed as a pod inside of a cluster having a load balancer that is to be optimized. For example, the load balancer optimization engine (LBOE) 140 of the present disclosure can be deployed within a pod executed in a node 104 of FIG. 1. In some examples, the load balancer optimization engine can be executed in response to a triggering event (e.g., a change/event happened, such as a node being added in or deleted from the cluster, and/or replicas of Ingress-nginx pod changxed due to a horizontal pod autoscaler (HPA)) and/or on a regular schedule (e.g., as a cronjob in Kubernetes). In some examples, the load balancer optimization engine includes multiple layers. Example layers include a data aggregation layer, an optimization decision layer, and an optimization operation layer.

In general terms, the load balancer optimization engine, and Kubernetes itself, are provided as computer-executable code that is executed in either a virtual machine (VM) or container. For Kubernetes, both the control plane 102 and the nodes 104 are executed in VMs provided by a cloud infrastructure provider or on-premise private data center. In some examples, Kubernetes calls the cloud platform to bootstrap one or more load balancers in the cloud infrastructure. The load balancers effectively function as a reverse proxy to expose services external to Kubernetes.

In some implementations, a usage metrics fetch module of the data aggregation layer receives a pool count from a configuration map. The pool count represents a number of nodes that are needed in the pool of nodes (pool members) for handling requests directed by a load balancer. In some examples, the pool count is a static value of a parameter default_backend_pool_count from the configuration map (lbopt) by default. The configuration map can be described as a mechanism that can be used to inject configuration data into pods. In some implementations, the pool count can be a dynamic value by, for example, adding a parameter pool_count_api in the configuration map. If the parameter pool_count_api is included in the configuration map, the usage metrics fetch module calls an application programming interface (API) to fetch and calculate the pool count. The API can be either any reachable external monitoring system (e.g., Prometheus) or the endpoint metrics exposed by any pod or service in the cluster. For example, an Ingress-nginx pod (which can be described as a controller that exposes HTTP and HTTPS routes from outside the cluster to services within the cluster) can expose metrics representative of usage of the cluster. An example metric can include a total number of requests processed in the cluster for a defined period of time (e.g., nginx_ingress_controller_nginx_process_requests_total). For example, a total number of client requests per minute can be calculated by a delta function (e.g., of Prometheus, which can monitor usage of the cluster). By way of non-limiting example, in can be determined that each Ingress-nginx pod is to serve, at most, 1,000 requests per minute. A record rule can be customized in Prometheus to indicate how many Ingress-nginx replicas should be there in the cluster. This metric is dynamic based on client requests and can be fetched by the load balancer optimization engine as a candidate node count through the Prometheus API. Regardless of how the pool count is determined (e.g., static vs. dynamic), the pool count is indicative of how many nodes a service needs, or will need, in order to execute the requests the service receives in a timely fashion (e.g., avoiding bottlenecks). As will be described later, this information is then used by the load balancing system associated with that service to add or subtract nodes available to execute requests for that service.

In some examples, a node status fetch module of the data aggregation layer can call the Kubernetes API of nodes to scan the status of each node in the cluster and identify nodes that do not include the exclude label (node.kubernetes.io/exclude-from-external-load-balancers). Nodes that do not include the exclude label are added to a candidate node list meaning those nodes are available for use by a service. If a node status does include the exclude label, it has been assigned to one or more services and should not be made available for other services and is thereby not added to the candidate list.

In some implementations, a decision module of the optimization decision layer processes the pool count (A) and a number of nodes (B) in the candidate node list to selectively add or remove nodes from the pool of nodes for load balancing. Here, a pool update module of the optimization operation layer applies label operations to nodes. In some examples, if one or more nodes are to be removed from the pool of nodes, the exclude label is added to the one or more nodes. If one or more nodes are to be added to the pool of nodes, the exclude label is removed from the one or more nodes. Nodes that exclude labels are removed from or added to can be referred to as delta nodes.

In some examples, the number of nodes provisioned in the cluster can change over time. For example, nodes can be added to or removed from the cluster as a result of scaling. As another example, nodes can be replaced within the cluster, which can occur in response to an issue with a node (e.g., an error in a node requiring the node to be replaced by another node). As a consequence, the number of nodes (B) in the candidate node list can be dynamic, even in instances where the pool count (A) is static.

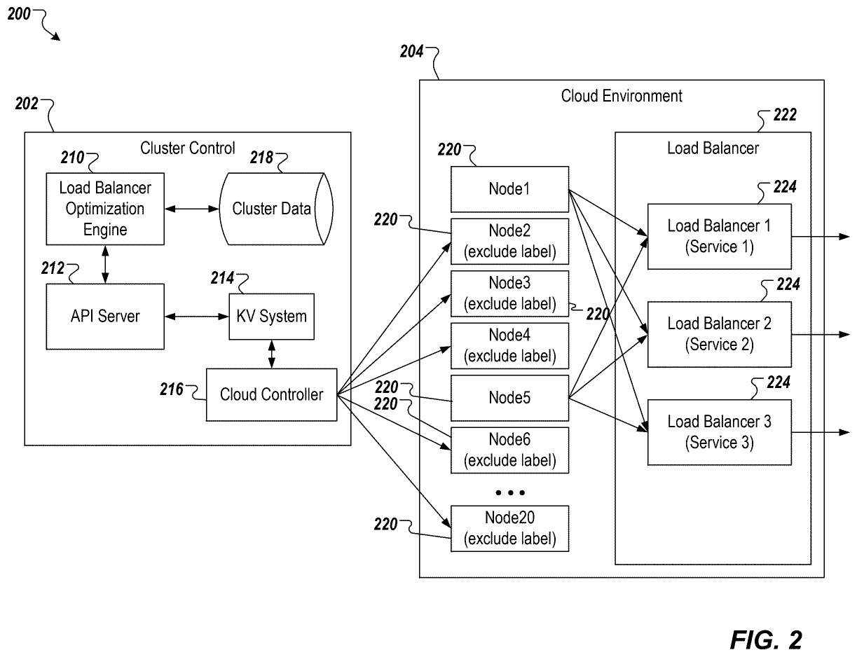

FIG. 2 depicts an example architecture 200 that can be used to execute implementations of the present disclosure. The example of FIG. 2 includes a cluster control 202 and a cloud environment 204. In the context of FIG. 1, components of the cluster control 202 are executed in the control plane 102. For example, the cluster control 202 can be deployed in one or more dedicated nodes (e.g., nodes 104 of FIG. 1), which only run control plane components with high availability, while other nodes are provided for application and/or workload.

In some implementations, the cluster control 202 includes a load balancer optimization engine 210, an API server 212, a key-value system 214, a cloud controller 216, and a cluster data store 218. The cloud environment 204 includes nodes 220 and a load balancer 222. In some examples, one or more nodes 220 are included as pool members in a pool of nodes for load balancing, as described in further detail herein. In some examples, the cloud environment 204 represents a cluster that includes the nodes 220. In the example of FIG. 2, twenty (20) nodes are provided in the cluster, one or more of the nodes being capable of being added to or removed from the pool of nodes used for load balancing.

In further detail, the load balancer optimization engine 210 can determine whether the number of nodes in the pool of nodes is to be adjusted and, if so, determine whether to add or remove nodes from the pool of nodes. In some examples, the load balancer optimization engine 210 determines the pool count (A) and a number of nodes (B) in a candidate node list. For example, the load balancer optimization engine 210 reads a configuration map stored in the cluster data store 218 to determine the pool count (A). As another example, the load balancer optimization engine 210 reads an API parameter from a configuration map stored in the cluster data store 218 to retrieve usage statistics and determine the pool count (A). In some examples, the load balancer optimization engine 210 requests the candidate node list from the API server 212. In some examples, a record for each node is stored in the key-value system 214, each record having an indication of whether a respective node has the exclusion label applied thereto. For example, a record can include a node identifier (node_ID) of a respective node and a label indicator to indicate whether the exclude label is to be applied to the respective node. In some examples, the key-value system 214 can be a key-value storage system that facilitates configuration of resources, discovery of services, and the coordination of distributed systems (e.g., clusters, containers). An example key-value storage system includes ETCD provide by the Cloud Native Computing Foundation.

In some implementations, the load balancer optimization engine 210 determines whether the pool count (A) exceeds the number of nodes (B) in the candidate node list. If the pool count (A) exceeds the number of nodes (B) in the candidate node list, the load balancer optimization engine 210 can determine a number of delta nodes (e.g., as a difference (delta value) between A and B) that the exclude label is to be added to. If the pool count (A) does not exceed the number of nodes (B) in the candidate node list, the load balancer optimization engine 210 can determine a number of delta nodes (e.g., as a difference (delta value) between A and B) that the exclude label is to be removed from. In some examples, if the pool count (A) is equal to the number of nodes (B) in the candidate node list no changes are made.

In some implementations, if the exclude label is to be added to or removed from delta nodes, the load balancer optimization engine 210 transmits a request through the API server 212 to request that the exclude label be added to or removed from the number of delta nodes. In some examples, in response to the request, the KV system 214 changes the records of one or more nodes to effect the change. For example, in response to a request to remove the exclude label from X nodes, the KV system 214 can randomly select X nodes that include the exclude label and adjust the records to remove the exclude label. As another example, in response to a request to add the exclude label to X nodes, the KV system 214 can randomly select X nodes that do not include the exclude label and adjust the records to add the exclude label.

In some implementations, the cloud controller 216 is prompted to adjust exclude labels of the nodes 220 in response to the requests. For example, the cloud controller 216 can periodically query the KV system 214 and can adjust exclude labels in response to determining differences in records since the cloud controller 216 last queried the KV system 214. As another example, in response to a request, the KV system 214 can trigger the cloud controller 216 to read the records. In some examples, the cloud controller 216 adds exclude labels to or removes exclude labels from nodes based on the records stored in the KV system.

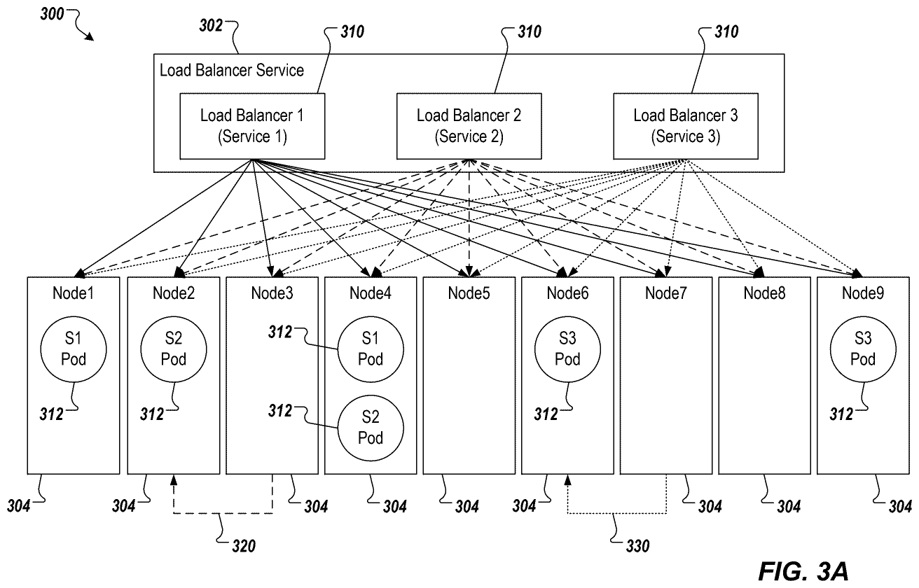

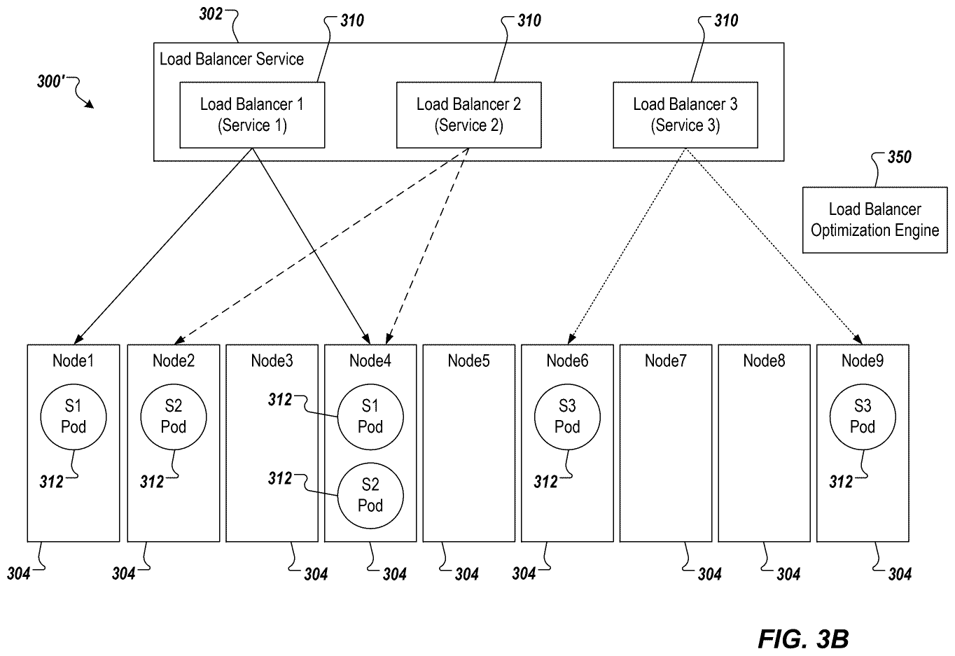

To highlight technical improvements achieved by implementations of the present, example load balancing scenarios schematically depicted in FIGS. 3A and 3B can be considered.

FIG. 3A depicts example load balancing 300 absent implementations of the present disclosure. The example of FIG. 3A balances loads on three services S1, S2, S3 and includes a load balancer service 302 and nodes 304. The load balancer service 302 includes load balancers 310, each load balancer 310 corresponding to a respective service S1, S2, S3. Instances of the services S1, S2, S3 are executed in pods 312 of the nodes 302. In the example of FIG. 3A, a first node 304 includes a pod 312 that executes an instance of the service S1, a second node 304 includes a pod 312 that executes an instance of the service S2, a fourth node 304 includes a pod 312 that executes an instance of the service S1 and a pod 312 that executes an instance of the service S2, a sixth node 304 executes an instance of the service S3, and a ninth node 304 executes an instance of the service S3.

In the example of FIG. 3A, 27 pool members are required in view of the three services S1, S2, S3 and nine nodes 304, because each node 304 has to be added to a load balancer pool of each of the load balancers 310. In this example, each load balancer 310 routes and checks all of the nodes 304 and sends requests to all of the nodes 304 (or manages a health check for the nodes 304). Internally, each node 304 has to route the requests to a node 304 where that instance of the service is running. For example, in response to receiving a request for the service S2, a third node 304 must route 320 the request to a node 304 that executes an instance of the service S2, such as the second node 304. As another example, in response to receiving a request for the service S3, a seventh node 304 must route 330 the request to a node 304 that executes an instance of the service S3, such as the sixth node 304.

Sending requests to all pool members, then pool members routing requests to correct pool members (e.g., pool members executing services of the requests) increases latency in handling of requests and consumes a considerable amount of technical resources (e.g., CPU, memory, network bandwidth). While the example of FIG. 3A is for a relatively small example of three services and nine nodes, practical scenarios can include, for example, upwards of 100 or more services and 1000 or more nodes. Here, 100 services with 1000 nodes results in 100,000 pool members for load balancing. In such practical scenarios, the increase in latency and in consumption of technical resources is considerably multiplied. As such, the example of FIG. 3A does not scale and would require instantiation of additional clusters further consuming technical resources.

In contrast to FIG. 3A, FIG. 3B depicts example load balancing 300′ in accordance with implementations of the present disclosure. The example of FIG. 3B is consistent with the example of FIG. 3A, except that the example of FIG. 3B includes a load balancer optimization engine 350 of the present disclosure. Here, the load balancer optimization engine 350 routes requests of the load balancers 310 to nodes 304 that execute the instances of the respective services S1, S2, S3. That is, for example, requests from the load balancer 310 corresponding to the service S1 are routed to the first node 304 and/or the fourth node 304, requests from the load balancer 310 corresponding to the service S2 are routed to the second node 304 and/or the fourth node 304, and requests from the load balancer 310 corresponding to the service S3 are routed to the sixth node 304 and/or the ninth node 304.

In the example of FIG. 3B, only five pool members are needed, instead of the nine pool members of the example of FIG. 3A. Further, none of the nodes 304 need route requests to other nodes 304 as occurs in the example of FIG. 3A (e.g., the routings 320, 330). In this manner, the load balancer optimization engine 350 of the present disclosure decreases latency in handling of requests and in consumption of technical resources. This enables scaling (e.g., practical scenarios of 100 or more services and/or 1000 or more nodes).

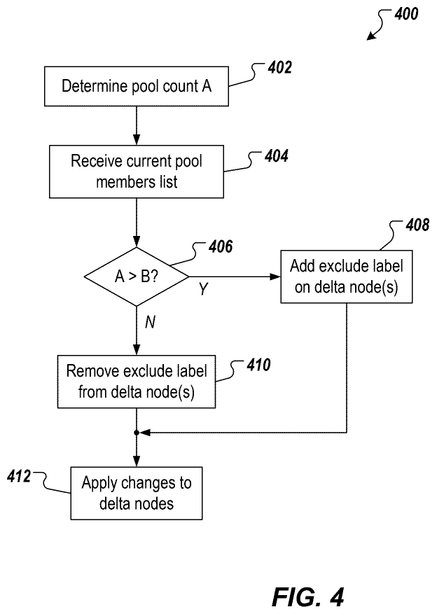

FIG. 4 depicts an example process 400 that can be executed in accordance with implementations of the present disclosure. In some examples, the example process 400 is provided using one or more computer-executable program executed by one or more computing devices.

A pool count A is determined (402). For example, and as described in detail herein, the pool count indicates a number of nodes that are to be available to a load balancer for handling requests to services executed within a cluster. In some examples, the pool count is a static value determined from a configuration map. In some examples, the pool count is a dynamic value that is determined from data retrieved through a call to an API indicated in the configuration map. A pool member list is received (404). For example, and as described in detail herein, the load balancer optimization engine 210 makes a call to the API server 212 to query the KV system 214 to provide a candidate node list. In some examples, the candidate node list includes all nodes that currently have the exclude label applied thereto.

It is determined whether the pool count A is greater than the number of pool members B in the pool member list (406). If the pool count A is greater than the number of pool members B in the pool member list, the exclude label is added to one or more delta nodes (408). For example, and as described in detail herein, the load balancer optimization engine 210 determines a delta value (difference) between A and B and sends a request through the API server 312 for the exclude label to be added to a number of nodes equal to the delta value. In some examples, the KV system 214 randomly selects nodes that do not currently have the exclude label applied (as delta nodes) and changes their respective records to indicate that the exclude label is to be applied. If the desired pool count A is not greater than the number of pool members in the current pool member list B, the exclude label is removed from one or more delta nodes (410). For example, and as described in detail herein, the load balancer optimization engine 210 determines a delta value between A and B and sends a request through the API server 312 for the exclude label to be removed from a number of nodes equal to the delta value. In some examples, the KV system 214 randomly selects nodes that currently have the exclude label applied (as delta nodes) and changes their respective records to indicate that the exclude label is to be removed.

Changes are applied to the delta nodes (412). For example, and as described in detail herein, the cloud controller 216 is prompted to adjust exclude labels of the nodes 220 in response to the requests. For example, the cloud controller 216 can periodically query the KV system 214 and can adjust exclude labels in response to determining changes to records since the cloud controller 216 last queried the KV system 214. As another example, in response to a request, the KV system 214 can trigger the cloud controller 216 to read the records. In some examples, the cloud controller 216 adds exclude labels to or removes exclude labels from nodes based on the records stored in the KV system.

As discussed in detail herein, implementations of the present disclosure provide multiple technical improvements over traditional approaches to load balancing in container orchestration systems, such as Kubernetes. For example, and as described herein, the load balancer optimization engine of the present disclosure reduces latency and consumption of technical resources (processors, memory, bandwidth) in handling requests to services in cloud computing environments. More generally, implementations of the present disclosure provide for improved resource utilization, cost reduction, streamlined operations, and intelligent load balancer management. Further, implementations of the present disclosure have extensive applicability with broad potential in enhancing load balancing efficiency. This can include use cases involving cloud computing providers, enterprise information technology (IT) departments, managed Kubernetes service providers, and hybrid-and multi-cloud environments.

For example, cloud computing providers that offer Kubernetes-based infrastructure can implement the load balancer optimization system to optimize resource utilization and reduce costs. As described herein, the load balancer optimization system enables efficient management of load balancers, ensuring that network resources are released and available for other customers or scaling needs. As another example, enterprise IT departments with Kubernetes deployments in their IT infrastructure can benefit from the load balancer optimization system of the present disclosure, which automates the improvement of resource utilization, reduced network costs, and streamlined operations. As another example, managed Kubernetes service providers can integrate the load balancer optimization system into their offerings, providing an added value to their customers by enhancing resource optimization, reduce operational overhead, and delivering a more efficient and cost-effective Kubernetes experience. As still another example, organizations operating in hybrid or multi-cloud environments, with Kubernetes clusters across different cloud providers, can deploy the load balancer optimization system of the present disclosure to provide an intelligence solution for load balancer management, irrespective of the underlying cloud infrastructure.

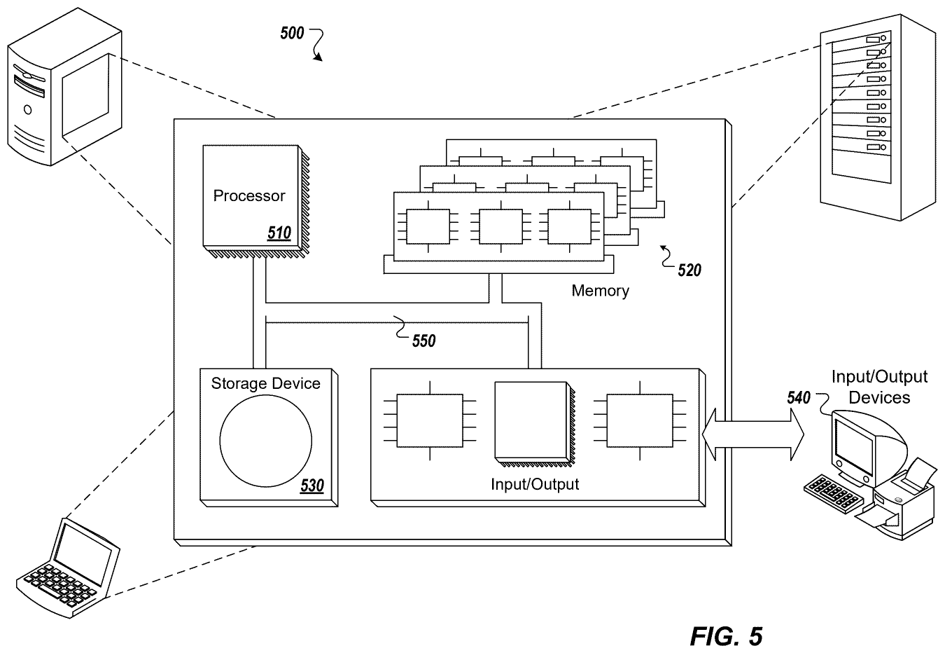

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for dynamically optimizing a pool of nodes used for load balancing in a container orchestration system, the method being executed by one or more processors and comprising:
executing a load balancer optimization engine for a cluster that includes a set of nodes, a first sub-set of nodes being used for load balancing by one or more external load balancers, a second sub-set of nodes being excluded from load balancing;
determining, by the load balancer optimization engine, a delta value based on a pool count and a number of nodes in a candidate node list;
transmitting, by the load balancer optimization engine, a request to adjust a number of nodes in the first sub-set of nodes and a number of nodes in the second sub-set of nodes responsive to the delta value; and
adjusting, by a cloud controller of the cluster, the number nodes in the first sub-set of nodes by the delta value and a number of nodes in the second sub-set of nodes by the to the delta value.

2. The method of claim 1, wherein the pool count is determined as a configuration parameter stored in a configuration map of the cluster.

3. The method of claim 1, wherein the pool count is determined based on usage metrics of the cluster.

4. The method of claim 1, wherein the candidate node list comprises one or more nodes in the first sub-set of nodes prior to adjusting the number nodes in the first sub-set of nodes by the delta value.

5. The method of claim 1, wherein each node in the first sub-set of nodes is absent an exclude label applied thereto and each node in the second sub-set of nodes includes the exclude label applied thereto.

6. The method of claim 1, wherein adjusting, by a cloud controller of the cluster, the number nodes in the first sub-set of nodes by the delta value and a number of nodes in the second sub-set of nodes by the to the delta value comprises one of:
adding an exclude label to a number of nodes in the first sub-set of nodes equal to the delta value, and
removing an exclude label from a number of nodes in the second sub-set of nodes equal to the delta value.

7. The method of claim 1, wherein adjusting, by a cloud controller of the cluster, the number nodes in the first sub-set of nodes by the delta value and a number of nodes in the second sub-set of nodes by the to the delta value comprises:
reading node records in a key-value system, each node record representing a respective node of the cluster and a label status of the respective node; and
identifying nodes in the node records that have had a change in label status.

8. A non-transitory computer-readable storage medium coupled to one or more processors and having instructions stored thereon which, when executed by the one or more processors, cause the one or more processors to perform operations for dynamically optimizing a pool of nodes used for load balancing in a container orchestration system, the operations comprising:
executing a load balancer optimization engine for a cluster that includes a set of nodes, a first sub-set of nodes being used for load balancing by one or more external load balancers, a second sub-set of nodes being excluded from load balancing;
determining, by the load balancer optimization engine, a delta value based on a pool count and a number of nodes in a candidate node list;
transmitting, by the load balancer optimization engine, a request to adjust a number of nodes in the first sub-set of nodes and a number of nodes in the second sub-set of nodes responsive to the delta value; and
adjusting, by a cloud controller of the cluster, the number nodes in the first sub-set of nodes by the delta value and a number of nodes in the second sub-set of nodes by the to the delta value.

9. The non-transitory computer-readable storage medium of claim 8, wherein the pool count is determined as a configuration parameter stored in a configuration map of the cluster.

10. The non-transitory computer-readable storage medium of claim 8, wherein the pool count is determined based on usage metrics of the cluster.

11. The non-transitory computer-readable storage medium of claim 8, wherein the candidate node list comprises one or more nodes in the first sub-set of nodes prior to adjusting the number nodes in the first sub-set of nodes by the delta value.

12. The non-transitory computer-readable storage medium of claim 8, wherein each node in the first sub-set of nodes is absent an exclude label applied thereto and each node in the second sub-set of nodes includes the exclude label applied thereto.

13. The non-transitory computer-readable storage medium of claim 8, wherein adjusting, by a cloud controller of the cluster, the number nodes in the first sub-set of nodes by the delta value and a number of nodes in the second sub-set of nodes by the to the delta value comprises one of:
adding an exclude label to a number of nodes in the first sub-set of nodes equal to the delta value, and
removing an exclude label from a number of nodes in the second sub-set of nodes equal to the delta value.

14. The non-transitory computer-readable storage medium of claim 8, wherein adjusting, by a cloud controller of the cluster, the number nodes in the first sub-set of nodes by the delta value and a number of nodes in the second sub-set of nodes by the to the delta value comprises:
reading node records in a key-value system, each node record representing a respective node of the cluster and a label status of the respective node; and
identifying nodes in the node records that have had a change in label status.

15. A system, comprising:
a computing device; and
a computer-readable storage device coupled to the computing device and having instructions stored thereon which, when executed by the computing device, cause the computing device to perform operations for dynamically optimizing a pool of nodes used for load balancing in a container orchestration system, the operations comprising:
executing a load balancer optimization engine for a cluster that includes a set of nodes, a first sub-set of nodes being used for load balancing by one or more external load balancers, a second sub-set of nodes being excluded from load balancing;
determining, by the load balancer optimization engine, a delta value based on a pool count and a number of nodes in a candidate node list;
transmitting, by the load balancer optimization engine, a request to adjust a number of nodes in the first sub-set of nodes and a number of nodes in the second sub-set of nodes responsive to the delta value; and
adjusting, by a cloud controller of the cluster, the number nodes in the first sub-set of nodes by the delta value and a number of nodes in the second sub-set of nodes by the to the delta value.

16. The system of claim 15, wherein the pool count is determined as a configuration parameter stored in a configuration map of the cluster.

17. The system of claim 15, wherein the pool count is determined based on usage metrics of the cluster.

18. The system of claim 15, wherein the candidate node list comprises one or more nodes in the first sub-set of nodes prior to adjusting the number nodes in the first sub-set of nodes by the delta value.

19. The system of claim 15, wherein each node in the first sub-set of nodes is absent an exclude label applied thereto and each node in the second sub-set of nodes includes the exclude label applied thereto.

20. The system of claim 15, wherein adjusting, by a cloud controller of the cluster, the number nodes in the first sub-set of nodes by the delta value and a number of nodes in the second sub-set of nodes by the to the delta value comprises one of:
adding an exclude label to a number of nodes in the first sub-set of nodes equal to the delta value, and
removing an exclude label from a number of nodes in the second sub-set of nodes equal to the delta value.
